(19) United States
(12) Patent Application Publication
(10) Pub. No.: US 2011/0029856 A1
(43) Pub. Date: Feb. 3, 2011

(54) Extensible Web Context in Web Containers

(75) Inventor: Soma Naganna Shekar, Bangalore (IN)

Correspondence Address: IBM SVL (Anthony England), PO Box 5307, Austin, TX, 78763-5307, US

(73) Assignee: INTERNATIONAL BUSINESS MACHINES CORPORATION, Armonk, NY (US)

(21) Appl. No.: 12/510,889

(22) Filed: Jul. 28, 2009

(51) Int. Cl. G06F 17/00; G06F 17/30

(52) U.S. Cl. 715/234; 707/E17.014

(57) ABSTRACT

Dynamically adding customized web content to an enterprise application through an extended directory. Content is rendered on a web browser on receiving a request from the web browser. Rendering the content includes merging multiple content stored as enterprise web content and any customized web content associated with the enterprise web content. The enterprise web content is stored in a first repository and the customized web content is stored in a second repository.

### TECHNICAL FIELD

This disclosure generally relates to the field of computer science, and more particularly to a method for preparing deployment content.

### TRADEMARKS

IBM® is a registered trademark of International Business Machines Corporation, Armonk, N.Y., U.S.A. Other names used herein may be registered trademarks, trademarks or product names of International Business Machines Corporation or other companies. Microsoft® is a registered trademark of Microsoft Corporation. Java® is a registered trademark of Sun Microsystems, U.S.A.

### BACKGROUND

Enterprise applications are typically large software applications that are used by many customers or users, such as employees of a business. These applications usually have multiple components that interact with one another and with other systems to perform various tasks. Enterprise applications include, e.g., enterprise resource planning, customer relationship management, and electronic messaging systems.

Enterprise applications, for example JavaEE/J2EE applications, may offer and/or require customizations at various levels. For example, an enterprise application may include enterprise web content, such as an enterprise archive, while supporting customization of certain web content, including, but not limited to custom images, HTML files, JavaScript files, and/or JSPs (Java serviets).

Enterprise applications may comprise multiple repositories. As an example, an enterprise application may comprise a repository of components delivered by a vendor and a repository of components added by a business. Repositories comprise components of an enterprise application. As an example, a repository may contain UI or logic components of an enterprise application. When administrators upgrade the enterprise application, they may need to again expend considerable resources in reapplying their customizations, which could increase the total cost of ownership of such enterprise applications. It would thus be desirable to upgrade enterprise applications without incurring such additional costs.

Existing techniques such as the hot deployment method and the repackaging method do not separate the enterprise application provider content from the customized content. The lack of this separation may lead to issues associated with manageability and/or licensing aspects of the enterprise application. It may also increase difficulties associated with rebuilding the enterprise application when a new version is released (product upgrade).

### SUMMARY

Methods available for incorporating and/or modifying the customized content may employ a technique referred to as hot deployment. Hot deployment is a technique where web content, for example jsp, html, etc., may be added to an application without restarting the application server or Web Server or the likes. Utilizing hot deployment, the application server extracts both the enterprise web content as well as the customized content from specific locations, which allows for modifications and/or new additions of customized content. Other methods available for incorporating and/or modifying customized content may include repackaging the enterprise application with updated EAR and/or Web Archive (WAR) files.

Embodiments of the invention are directed to a method and system for deploying content where content is rendered on a web browser on receiving a request from the web browser, wherein rendering the content includes merging multiple content stored as enterprise web content and any customized web content associated with the enterprise web content, and wherein the enterprise web content is stored in a first repository and the customized web content is stored in a second repository.

In a further embodiment, a root entry is stored in a configuration file as a link to the enterprise web content stored in the first repository, and storing/recording as a child entry in the same configuration file, a link to the customized web content stored in the second repository.

In a further embodiment, the web content and the customized web content comprises at least one of an image, or video, or audio, or text, or markup language or script. It will be clears to one skilled in the art that various other formats of content fall within the scope of the embodiment of this invention. On receiving a request from the user, an embodiment comprises: locating the enterprise web content stored in the first repository; checking the configuration file if there exists any customized web content associated with the enterprise web content; and linking the enterprise web content to the customized web content prior to rendering the content to the user. The first repository containing the enterprise web content and the second repository containing the customized web content is hosted on an applications server.

Embodiments of the invention also include a method and system of preparing deployment content, wherein the enterprise web content is stored in a first repository on an application server; defining a root entry in a configuration file indicating the location of the enterprise web content on the application server; adding customized web content to the enterprise web content; storing the customized web content in a second repository on the application server; and adding a child entry in the configuration file indicating the location of the customized web content on the application server.

On receiving a request for rendering the enterprise web content from a web browser, an embodiment comprises: checking the configuration file for any child entries; merging the enterprise web content stored in the first repository to the customized web content stored in the second repository by using information in the configuration file; and rendering the merged content on the browser. Any new customized web content added to the enterprise web content is stored in the second repository. A child entry is created in the configuration file for all new customized web content stored in the second repository. Multiple child entries are stored as a hierarchical arrangement.

Embodiments of the invention are directed to a method for dynamically adding customized web content to a Java enterprise application through an extended directory. The method may comprise receiving a configuration file specifying information comprising a enterprise web content and a customized web content; obtaining a primary application directory from the configuration file; obtaining an extended application directory from the configuration file, wherein the extended application directory is different from the primary application directory; searching the enterprise web content in the primary application directory; searching the enterprise web content in the extended application directory when the enterprise web content does not exist in the primary application directory; searching the customized web content in the extended application directory; reporting an exception when the one of the enterprise web content and customized web content does not exist; and rendering the enterprise web content and the customized web content.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

These and further aspects of exemplary embodiments the invention will become apparent from and will be elucidated hereinafter with reference made to the accompanying drawings. The drawings illustrate only exemplary embodiments of the invention, and together with the description, serve to further explain the embodiments disclosed. The numerous advantages of the disclosure may be better understood by those skilled in the art by reference to the accompanying FIGS.

FIG. 1 is a data processing system of an exemplary embodiment of the invention;

FIG. 2 illustrates a block architecture of rendering content to a user; and

FIG. 3 is a flow diagram illustrating a method for preparing deployment content of an enterprise application.

### DETAILED DESCRIPTION

Reference will now be made in detail to the subject matter disclosed, which is illustrated in the accompanying drawings.

Java enterprise applications (Java EE/J2EE applications) may offer and/or require customizations at various levels. For example, an enterprise application may include an enterprise web content (e.g., an enterprise archive) while supporting customization of certain extended content.

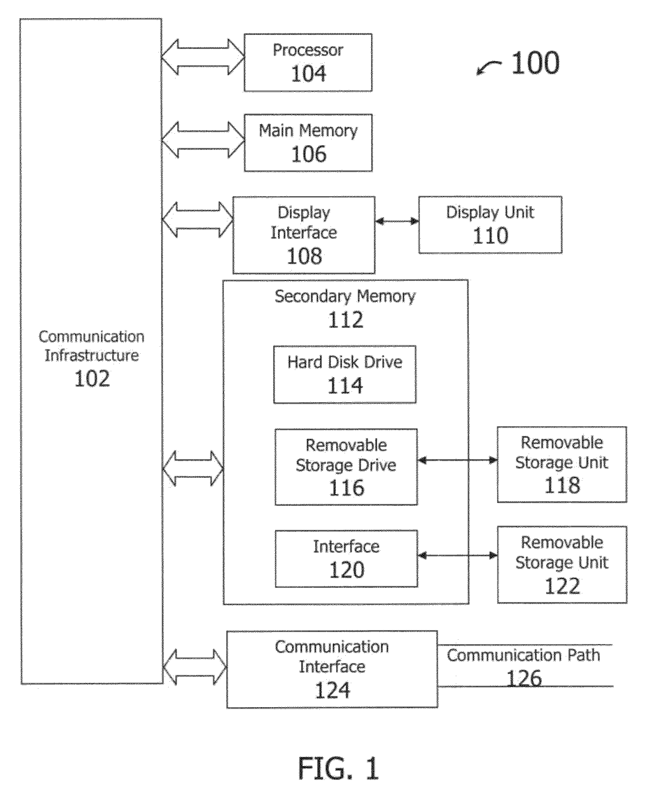

FIG. 1 illustrates a block diagram of an exemplary data processing system 100, for example a computing system such as a desktop computer, laptop computer, PDA, mobile phone and the likes, that can be used for implementing exemplary embodiments of the present invention. Data processing system 100 includes one or more processors, for example processor 104 as illustrated in FIG. 1. Processor 104 is coupled to a communication infrastructure 102 (for example, a communications bus, cross-over bar, or network). Various software embodiments are described in terms of this exemplary data processing system. After reading this description, it will become apparent to a person of ordinary skill in the relevant art(s) how to implement the invention using other data processing systems and/or computer architectures.

Exemplary data processing system 100 can include display interface 108 that forwards graphics, text, and other data from the communication infrastructure 102 (or from a frame buffer not shown) for display on display unit 110. Data processing system 100 also includes main memory 106, which can be random access memory (RAM), and may also include secondary memory 112. Secondary memory 112 may include, for example, hard disk drive 114 and/or removable storage drive 116, representing a floppy disk drive, a magnetic tape drive, an optical disk drive, etc. Removable storage drive 116 reads from and/or writes to removable storage unit 118 in a manner well known to those having ordinary skill in the art. Removable storage unit 118, represents, for example, a floppy disk, magnetic tape, optical disk, etc. which is read by and written to by removable storage drive 116. As will be appreciated, removable storage unit 118 includes a computer usable storage medium having stored therein computer software and/or data.

In exemplary embodiments, secondary memory 112 may include other similar means for allowing computer programs or other instructions to be loaded into the computer system. Such means may include, for example, removable storage unit 122 and interface 120. Examples of such may include a program cartridge and cartridge interface (such as that found in video game devices), a removable memory chip (such as an EPROM, or PROM) and associated socket, and other removable storage units 122 and interfaces 120 which allow software and data to be transferred from removable storage unit 122 to data processing system 100.

Data processing system 100 may also include a communications interface 124. Communications interface 124 allows software and data to be transferred between the data processing system and any other external devices. Examples of communications interface 124 may include a modem, a network interface (such as an Ethernet card), a communications port, a PCMCIA slot and card, etc. Software and data transferred via communications interface 124 are typically in the form of signals which may be, for example, electronic, electromagnetic, optical, or other signals capable of being received by communications interface 124. These signals are provided to communications interface 124 via communications path (that is, channel) 126. Channel 126 carries signals and may be implemented using wire or cable, fiber optics, a phone line, a cellular phone link, an RF link, and/or other communications channels.

The terms “computer program medium,” “computer usable medium,” and “computer readable medium” are used to generally refer to media such as main memory 106 and secondary memory 112, removable storage drive 116, a hard disk installed in hard disk drive 114, and signals thereof. Computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface, including a wired network or a wireless network, which allows a computer to read such computer readable information.

Computer programs (also called computer control logic) are typically stored in main memory 106 and/or secondary memory 112. Computer programs may also be received via communications interface 124. Such computer programs, when executed, can enable the computer system to perform the features of exemplary embodiments of the invention as discussed herein. In particular, computer programs, when executed, enable processor 104 to perform the features of data processing system 600. Accordingly, such computer programs represent controllers of the data processing system.

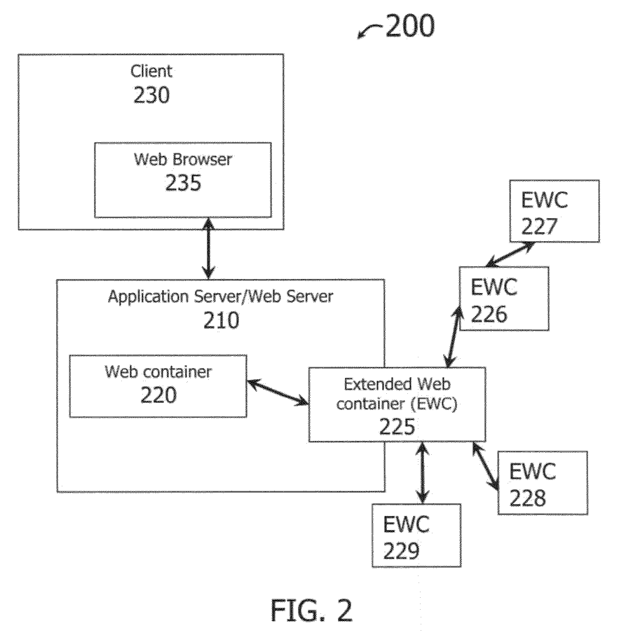

FIG. 2 illustrates block architecture 200 of rendering content to a user. Embodiments of the invention are directed to deploying and rendering content of an enterprise application. In one embodiment, the method may dynamically add customized web content through an extended directory (repository) where the deployed enterprise application is separate from the customization code (customized web content). Embodiments of the invention are also directed to provide an extension to the current web context where the application is deployed and a separate place holder for all the extended and/or customized content. Therefore, there is provided an extended web context directory (a web context is basically a directory or directory structure that is published on the web) where the customization of the web content (e.g., images, HTML files, JavaScript files, and/or JSPs) may be located. The method further provides a clear separation of the customized content from the enterprise application content, therefore reducing complexities associated with application support and product upgrade.

Client 230 includes-web browser 235 that is configured to make a request to application server 210, the application server configured to serve the request made by web browser 235 by rendering content to the web browser. Application server 210 contains a configuration file, wherein location of the information to be server to the request made is stored in the configuration file. Application server 210, on receiving request from web browser 235, first looks for the configuration file. The content to be served to the requester may be stored in web container 220, also referred to as a first repository. All such content stored in web container 220 is configured as a root entry in the configuration file. When a user needs to add any additional customized content that is related to the original content in web container 220, the user is allowed to create the content and store such customized content on an extended web container 225, also referred to as a second repository. All such customized content is stored as a child entry in the configuration file, linking the child entry to the root entry in the configuration file.

When a request is received by application server 210 for content, application server 210 checks the configuration file and links the content in web container 220 to the customized content in extended web container 225 and then renders the content, which includes the original enterprise content and the customized content on web browser 235. In one embodiment, the customized web content may be stored in multiple extended web containers (EWC) 226 . . . 229, and each of these has a child node or sub child node entry in the configuration file, thereby ensuring that the right content is server to web browser 235.

Therefore by this method, application server may dynamically add customized web content through an extended web container or extended directory (repository) where the deployed enterprise application is separate from the customization code (customized web content). Embodiments of the invention are also directed to provide an extension to the current web context where the application is deployed and a separate place holder for all the extended and/or customized content. Therefore, there is provided an extended web context directory (a web context is basically a directory or directory structure that is published on the web) where the customization of the web content (e.g., images, HTML files, JavaScript files, and/or JSPs) may be located.

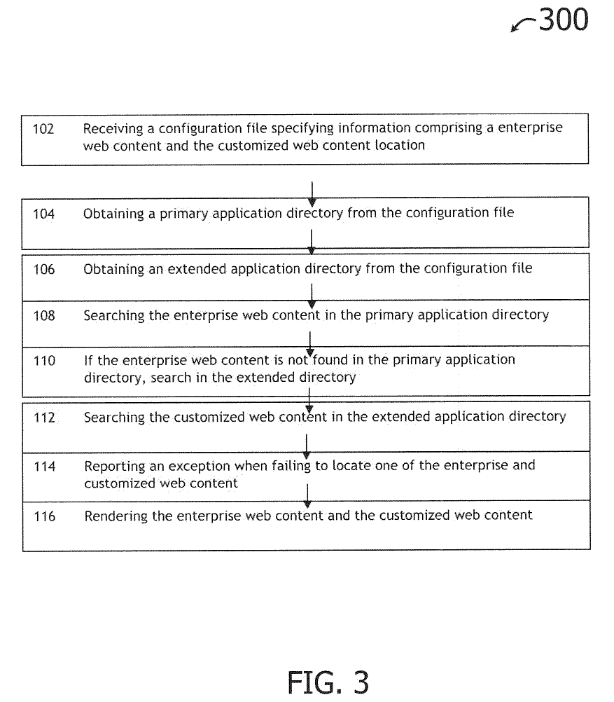

FIG. 3 illustrates a flow diagram illustrating steps performed by a method 300 in accordance with the present disclosure. The method may be utilized to prepare for deployment of a Java enterprise application. In one embodiment, step 102 receives a configuration file specifying resource information comprising an enterprise web content (content provided by the enterprise application provider, such as an enterprise archive file) and a customized web content (e.g., a customized archive file). The configuration file may be provided in any machine readable format. In one embodiment, the configuration file is provided as an application specific XML file. An exemplary XML file may state as follows:

```
<Context>
  <Application context=”\”
location=”<APP_SRV_PROFILE_INSTALL_APP_DIR>/ABC.war”>
    <Extended-application location=
”<APP_SRV_PROFILE_EXTENDED_APP_DIR>/
customdeployment.war”/>
  </Application>
</Context>
```

In the above example, “ABC.war” represents the content provided by the enterprise application provider, and “customdeployment.war” represents the customized web content. The enterprise web content and the customized web content may be identified by their corresponding XML tags. It is understood that the configuration file may be provided utilizing different tags and/or in different file formats.

Also provided in the configuration file is information specifying the directory where the enterprise web content is located (the primary application directory) and a different directory where the customized web content is located (the extended application directory). The primary and the extended application directories are obtained in steps 104 and 106, respectively. In the above example, the primary application directory is specified by environment variable APP_SRV_PROFILE_INSTALL_APP_DIR, and the extended application directory is specified by environment variable APP_SRV_PROFILE_EXTENDED_APP_DIR.

Environment variable APP_SRV_PROFILE_INSTALL_APP_DIR may specify the location where the enterprise provider content is deployed as Web Archive, and APP_SRV_PROFILE_EXTENDED_APP_DIR may specify the location where the customized web content may be deployed. It is contemplated that the configuration file comprising information regarding the files and their corresponding directories may be manually constructed, or generated utilizing a script and/or an administration console interface.

In one embodiment, when the deployment of the application starts, step 108 tries to locate the enterprise web content in the primary application directory. If the enterprise web content cannot be located in the primary application directory, step 110 then tries to locate the enterprise web content in the extended application directory. Step 112 tries to locate the customized web content in the extended application directory. If the enterprise web content and/or the customized web content cannot be located, step 114 reports an exception indicating the missing content. It is understood that the configuration file may specify multiple enterprise web content and/or customized web content. Once all resource files (enterprise and customized web content) are located, the resource files are rendered in step 116 and the deployment process continues.

Embodiments of the invention disclosed methods that may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Further, although process steps, method steps or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently. Further, some or all steps may be performed in run-time mode.

When a single element or article is described herein, it will be apparent that more than one element/article (whether or not they cooperate) may be used in place of a single element/article. Similarly, where more than one element or article is described herein (whether or not they cooperate), it will be apparent that a single element/article may be used in place of the more than one element or article. The functionality and/or the features of an element may be alternatively embodied by one or more other elements which are not explicitly described as having such functionality/features. Thus, other embodiments need not include the element itself.

Although embodiments of the invention have been described with reference to the embodiments described above, it will be evident that other embodiments may be alternatively used to achieve the same object. The scope is not limited to the embodiments described above, but can also be applied to software programs and computer program products in general. It should be noted that the above-mentioned embodiments illustrate rather than limit the invention and that those skilled in the art will be able to design alternative embodiments without departing from the scope of the appended claims. In the claims, any reference signs should not limit the scope of the claim. Embodiments of the invention can be implemented by means of hardware comprising several distinct elements.

What is claimed is:

1. A method for deploying content, comprising:
rendering content on a web browser-on receiving a request from the web browser, wherein rendering the content includes
merging multiple content stored as enterprise web content and any customized web content associated with the enterprise web content, and
wherein the enterprise web content is stored in a first repository and the customized web content is stored in a second repository.

2. The method of claim 1, further comprising:
storing as a root entry in a configuration file a link to the enterprise web content stored in the first repository.

3. The method of claim 2, further comprising:
storing, as a child entry in the configuration file a link to the customized web content stored in the second repository.

4. The method of claim 1, further comprising:
storing, as said web content or said customized web content, at least one of an image, or video, or audio, or text, or mark up language, or script.

5. The method of claim 1, further comprising:
upon receiving a request from the user, locating the enterprise web content stored in the first repository;
checking the configuration file if there exists any customized web content associated with the enterprise web content; and
linking the enterprise web content to the customized web content prior to rendering the content to the user.

6. The method of claim 1, further comprising:
hosting, on an application server, said first repository and said second repository.

7. A method of preparing deployment content, comprising:
storing enterprise web content in a first repository on an application server;
defining a root entry in a configuration file indicating a location of the enterprise web content on the application server;
adding customized web content to the enterprise web content;
storing the customized web content in a second repository on the application server; and
adding a child entry in the configuration file indicating the location of the customized web content on the application server.

8. The method of claim 7, further comprising:
on receiving a request for rendering the enterprise web content from a web browser, checking the configuration file for any child entries;
merging the enterprise web content stored in the first repository to the customized web content stored in the second repository by using information in the configuration file; and
rendering the merged content on the browser.

9. The method of claim 8, further comprising:
storing, in a second repository, any new customized web content added to the enterprise web content.

10. The method of claim 9, further comprising:
creating a child entry in the configuration file for all new customized web content stored in the second repository.

11. The method of claim 10, wherein the multiple child entries are stored as a hierarchical arrangement.

12. A method for deployment of application content, comprising:
receiving a configuration file specifying information including an enterprise web content and a customized web content;
obtaining a primary application directory from the configuration file;
obtaining an extended application directory from the configuration file, wherein the extended application directory is different from the primary application directory;
searching the enterprise web content in the primary application directory;
searching the enterprise web content in the extended application directory when the enterprise web content does not exist in the primary application directory;
searching the customized web content in the extended application directory;
reporting an exception when the one of the enterprise web content and customized web content does not exist; and
rendering the enterprise web content and the customized web content.

13. A program product for deploying content, comprising:
a computer usable medium having computer readable program code embodied therein to render content on a web browser on receiving a request from the web browser, wherein rendering the content includes merging multiple content stored as enterprise web content and any customized web content associated with the enterprise web content, and wherein the enterprise web content is stored in a first repository and the customized web content is stored in a second repository.

14. The program product of claim 13, further configured to store as a root entry in a configuration file, a link to the enterprise web content stored in the first repository, and storing as a child entry in the configuration file, a link to the customized web content stored in the second repository.

15. The program product of claim 13, wherein the web content and the customized web content comprises at least one of an image, or video, or audio, or text, or mark up language, or script.

16. The program product of claim 13, further configured, on receiving a request from the user, to
locate the enterprise web content stored in the first repository; to
check the configuration file if there exists any customized web content associated with the enterprise web content; and to
link the enterprise web content to the customized web content prior to rendering the content to-the user.

17. The program product of claim 13, further configured to host, on an application server, the first repository containing the enterprise web content and the second repository containing the customized web content.

18. A program product for preparing deployment content, comprising:
a computer usable medium having a computer readable program code embodied therein for
storing enterprise web content in a first repository on an application server;
defining a root entry in a configuration file indicating the location of the enterprise web content on the application server;
adding customized web content to the enterprise web content;
storing the customized web content in a second repository on the application server; and
adding a child entry in the configuration file indicating the location of the customized web content on the application server.

19. The program product of claim 18, further configured to, on receiving a request for rendering the enterprise web content from a web browser,
checking the configuration file for any child entries;
merging the enterprise web content stored in the first repository to the customized web content stored in the second repository by using information in the configuration file; and
rendering the merged content on the browser.

20. The program product of claim 18, further configured to store any new customized web content added to the enterprise web content in the second repository, and to create a child entry in the configuration file for all new customized web content stored in the second repository.
